(19) United States
(12) Patent Application Publication
(10) Pub. No.: US 2015/0236983 A1
(43) Pub. Date: Aug. 20, 2015

(54) APPARATUS AND METHOD FOR SETTING SWITCHES COUPLED IN A NETWORK DOMAIN

(71) Applicant: FUJITSU LIMITED, Kawasaki-shi (JP)

(72) Inventors: Misao MOROBAYASHI, Ashigarakami (JP); Masazumi TACHIBANA, Chiba (JP)

(73) Assignee: FUJITSU LIMITED, Kawasaki-shi (JP)

(21) Appl. No.: 14/605,198

(22) Filed: Jan. 26, 2015

(30) Foreign Application Priority Data
Feb. 20, 2014 (JP) 2014-031130

(51) Int. Cl. H04L 12/931

(52) U.S. Cl. CPC H04L 49/70

(57) ABSTRACT

An apparatus sets switches each belonging to a domain including two or more switches. A switch receives, from another switch, information including a domain identifier, a first switch identifier identifying another switch, and a first port identifier identifying a port via which the information is transmitted from another switch. The switch transmits, to the apparatus, connection data including the information and a second port identifier identifying a port via which the information is received by the switch. Upon receiving the connection data from the switch, the apparatus allocates a second switch identifier identifying the switch, transmits, to the switch, first setting data for setting the second switch identifier and setting a port identified by the second port identifier as an in-domain link port, and transmits, to another switch, second setting data for setting a port identified by the first port identifier as an in-domain link port.

### CROSS-REFERENCE TO RELATED APPLICATION

This application is based upon and claims the benefit of priority of the prior Japanese Patent Application No. 2014-031130, filed on Feb. 20, 2014, the entire contents of which are incorporated herein by reference.

### FIELD

The embodiment discussed herein is related to apparatus and method for setting switches coupled in a network domain.

### BACKGROUND

A network virtualized switch is a logical network switch that makes a network including a plurality of internal switches look like a single switch.

In the network virtualized switch, one or more domains, each including a plurality of internal switches, are defined. An in-domain link called Inter-Switch Link (ISL) is arranged between the plurality of internal switches included in a single domain. When a plurality of domains is defined, inter-domain links are arranged. Also arranged are links to connect a network virtualized switch to an external network and links to be connected to a server and a storage.

In accordance with design, a network implementer performs a cable connection for in-domain links, a cable connection for inter-domain links, and a cable connection with the other links. Internal switches typically used are frequently identical to each other. Performing the cable connection in an error-free fashion involves a considerable workload, and further a variety of settings are performed on each internal switch.

Techniques are available to automatically configure a network connection apparatus, but no techniques are currently available to focus on a domain defined in the network virtualized switch.

Those available techniques are disclosed in Japanese National Publication of International Patent Application No. 2004-537881, Japanese Laid-open Patent Publication No. 2002-9808, and Japanese National Publication of International Patent Application No. 2005-522774

### SUMMARY

According to an aspect of the invention, a system includes a plurality of switches and an information processing apparatus for setting the plurality of switches. The plurality of switches each include a memory and belong to one of one or more domains, where the one or more domains each include two or more switches belonging thereto, and a domain identifier identifying a domain to which each of the plurality of switches belongs is beforehand set to each switch. Each switch, upon receiving information from another switch in a state where a first switch identifier identifying the each switch is not set, store in the memory, as connection data, the information together with a first port identifier identifying a port of the each switch via which the information is received, where the information includes a domain identifier identifying a domain to which the another switch belongs, a second switch identifier identifying the another switch, and a second port identifier identifying a port of the another switch via which the information is transmitted from the another switch. Each switch reads out, from the memory, the connection data including a domain identifier identifying a domain to which the each switch belongs, and transmits, to the information processing apparatus, the connection data that includes the domain identifier, the first switch identifier, the first port identifier, and the second port identifier. The information processing apparatus, upon receiving the connection data from the each switch, allocate, as the first switch identifier, an identifier unique to a domain to which the each switch belongs, generates first setting data that is adapted to set the first switch identifier to the each switch that has transmitted the connection data and to set a port of the each switch identified by the first port identifier as an in-domain link port, and transmits the generated first setting data to the each switch that has transmitted the connection data. The information processing apparatus further generates second setting data that is adapted to set a port of the another switch identified by the second port identifier as an in-domain link port, and transmits the generated second setting data to the another switch identified by the second switch identifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network virtualized switch, according to an embodiment;

FIG. 2 is a diagram illustrating an example of a data flow of a network virtualized switch, according to an embodiment;

FIG. 3 is a diagram illustrating an example of a configuration of a network system, according to an embodiment;

FIG. 4 is a diagram illustrating an example of a functional block diagram of a switch, according to an embodiment;

FIG. 5 is a diagram illustrating an example of a functional block diagram of an apparatus setting server, according to an embodiment;

FIG. 6 is a diagram illustrating an example of an operational sequence to be performed by a network implementer, according to an embodiment;

FIG. 7 is a diagram illustrating an example of data stored in a basic data region, according to an embodiment;

FIG. 8 is a diagram illustrating an example of data stored in an address management region, according to an embodiment;

FIG. 9 is a diagram illustrating an example of an operational flowchart for a system, according to an embodiment;

FIG. 10 is a diagram illustrating an example of data stored in a basic data storage unit of a switch, according to an embodiment;

FIG. 11 is a diagram illustrating an example of an operational flowchart for a system, according to an embodiment;

FIG. 12 is a diagram illustrating an example of an operational flowchart for a setting generation process, according to an embodiment;

FIG. 13 is a diagram illustrating an example of data stored in a switch ID management region of an apparatus setting server, according to an embodiment;

FIG. 14 is a diagram illustrating an example of data stored in an address management region of an apparatus setting server, according to an embodiment;

FIG. 15 is a diagram illustrating an example of an operational flowchart for a setting generation process, according to an embodiment;

FIG. 16 is a diagram illustrating an example of a setting command generated for a first switch, according to an embodiment;

FIG. 17 is a diagram illustrating an example of data stored in a connection data storage unit of a switch, according to an embodiment;

FIG. 18 is a diagram illustrating an example of an operational flowchart for a system, according to an embodiment;

FIG. 19 is a diagram illustrating an example of a setting command generated for a second switch, according to an embodiment;

FIG. 20 is a diagram illustrating an example of a setting command generated for a first switch, according to an embodiment;

FIG. 21 illustrates an example of a network virtualized switch to which the embodiment is applicable;

FIG. 22 is a diagram illustrating an example of a network virtualized switch, according to an embodiment; and

FIG. 23 is a diagram illustrating an example of a configuration of a switch, according to an embodiment.

### DESCRIPTION OF EMBODIMENTS

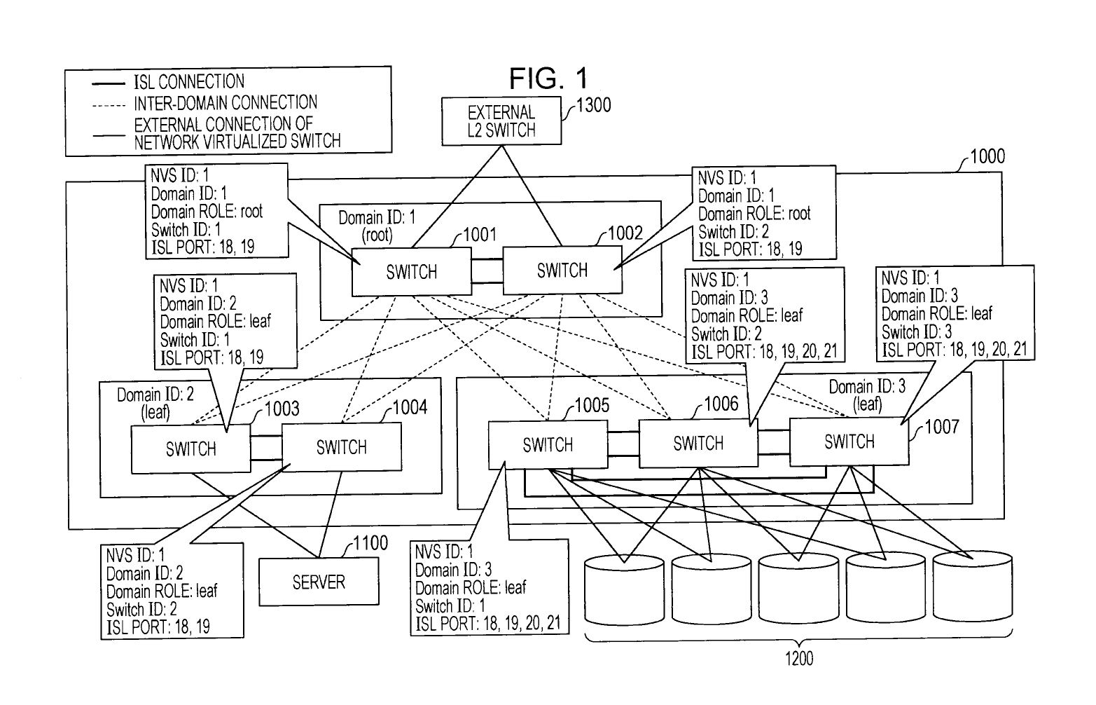

FIG. 1 is a diagram illustrating an example of a network virtualized switch, according to an embodiment. The network virtualized switch 1000 includes three domains. A domain 1 having a domain identification (ID) 1 is a root domain, and includes two switches 1001 and 1002. The switch 1001 and the switch 1002 in the domain 1 are connected via two ISLs represented by solid lines, and are connected to an external L2 (layer 2) switch 1300. The switch 1001 and the switch 1002 in the domain 1 are also connected to each switch in other domains via links represented broken lines.

A domain 2 having a domain ID 2 is not the root domain but a leaf domain, and includes two switches 1003 and 1004. The switches 1003 and 1004 in the domain 2 are connected to each other via two ISLs represented by two solid lines and are connected to the server 1100. The switches 1003 and 1004 in the domain 2 are connected to each switch in the domain 1 via links represented broken lines.

A domain 3 having a domain ID 3 is not the root domain but a leaf domain, and includes three switches 1005 through 1007. The switches 1005 through 1007 in the domain 3 are connected to each other via two ISLs represented by two solid lines. Each of the switches 1005 through 1007 in the domain 3 is connected to three or more storages 1200. The switches 1005 through 1007 in the domain 3 are connected to each switch in the domain 1 via links represented by broken lines.

For the network virtualized switch 1000 to operate appropriately, the switch 1001 in the domain 1 has the setting that the network virtualized switch (NVS) ID is “1”, the domain ID is “1”, the role of the domain is “root”, the switch ID of the domain 1 is “1”, and identifiers of the ISL ports are “18”, and “19”.

The switch 1002 in the domain 1 has the setting that NVS ID is “1”, the domain ID is “1”, the role of the domain is “root”, the switch ID in the domain 1 is “2”, and identifiers of the ISL ports are “18”, and “19”.

The switch 1003 in the domain 2 has the setting that NVS ID is “1”, the domain ID is “2”, the role of the domain is “leaf”, the switch ID in the domain 2 is “1”, and identifiers of the ISL ports are “18”, and “19”.

The switch 1004 in the domain 2 has the setting that NVS ID is “1”, the domain ID is “2”, the role of the domain is “leaf”, the switch ID in the domain 2 is “2”, and identifiers of the ISL ports are “18”, and “19”.

The switch 1005 in the domain 3 has the setting that NVS ID is “1”, the domain ID is “3”, the role of the domain is “leaf”, the switch ID in the domain 3 is “1”, and identifiers of the ISL ports are “18”, “19”, “20”, and “21”.

The switch 1006 in the domain 3 has the setting that NVS ID is “1”, the domain ID is “3”, the role of the domain is “leaf”, the switch ID in the domain 3 is “2”, and identifiers of the ISL ports are “18”, “19”, “20”, and “21”.

The switch 1007 in the domain 3 has the setting that NVS ID is “1”, the domain ID is “3”, the role of the domain is “leaf”, the switch ID in the domain 3 is “3”, and identifiers of the ISL ports are “18”, “19”, “20”, and “21”.

The port number is a value 1/2/0/1 in the number format of domain/switch ID/chassis ID/port. In the embodiment, the port number is described in a simple format as described above.

In these settings, each switch in the network virtualized switch 1000 automatically recognizes inter-domain link and performs other configurations, such as redundancy configuration.

As illustrated in FIG. 1, ISL of a domain of high value has a plurality of links to ensure a higher degree of redundancy or a higher performance in an alternative route.

The other configurations described above, such as the redundancy configuration, are based on the premise that the configurations described above are consistently performed. For example, in one inconsistent case, a switch of another domain is connected to an ISL port (although in a standard case, a switch of the same domain is typically connected). In another inconsistent case, the same switch ID as the switch ID of a switch of interest may be duplicated as a switch ID of a switch connected to an ISL port (although in a standard case, the switch ID is not duplicated).

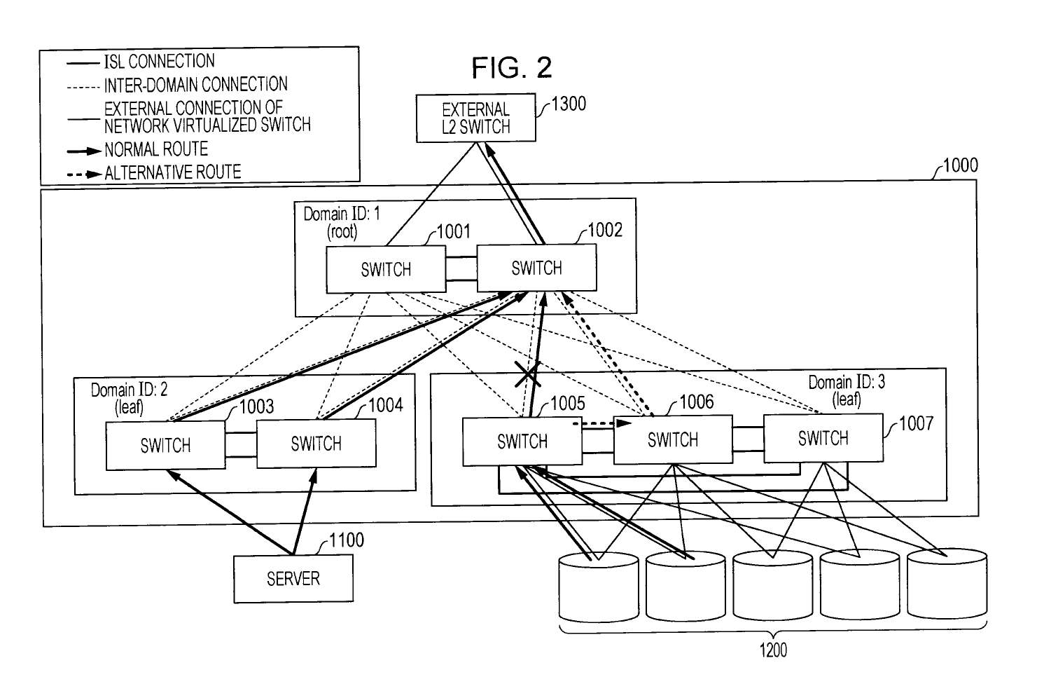

Without such an inconsistency, traffic from the server 1100 flows to the external L2 switch 1300 via the switches 1003 and 1004 in the domain 2 and the switches in the domain 1 as illustrated in FIG. 2. Load is thus more distributed than in the case that traffic flows only via the switches 1003 and 1004. More specifically, network performance is increased without increasing the performance of any single switch only.

When an inter-domain link between the switch 1005 and the switch 1002 is disconnected, traffic from the storage 1200 to the external L2 switch 1300 may be routed through the switch 1006 using the ISL between the switch 1005 and the switch 1006 as represented by heavy broken lines.

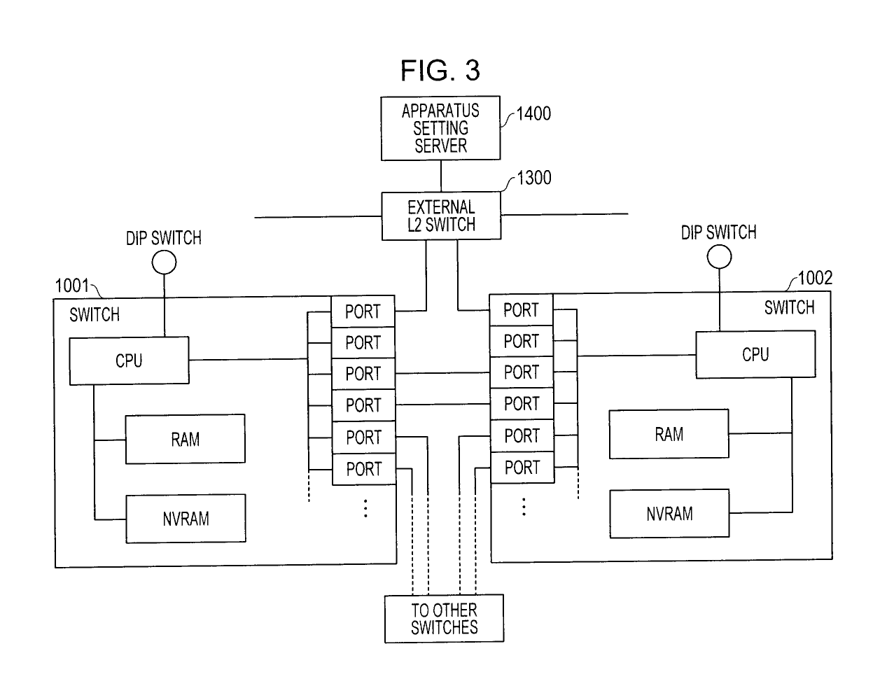

A mechanism to implement the configuration of FIG. 1 consistently while lightening a load on a network implementer is described with reference to FIG. 3 through FIG. 22.

Referring to FIG. 3, setting to the switches in the network virtualized switch 1000 is performed by an apparatus setting server 1400 connected to the external L2 switch 1300. FIG. 3 illustrates the two switches, namely, the switch 1001 and the switch 1002 in the network virtualized switch 1000. The other switches have the same setting as in the switch 1001 and the switch 1002.

Each of the switch 1001 and the switch 1002 includes a plurality of ports to be connected to other switches via a cable or the like, a central processing unit (CPU), a random access memory (RAM) that stores data under process and a program being executed, and non-volatile RAM (NVRAM) that stores setting data and a program. One feature of the switch of the embodiment is that a physical interface, such as a dual in-line package (DIP) switch or a dial, is arranged to set a domain ID to the switch. This allows the network implementer to easily set the domain ID to the switch, and also to make verification process after connection easy.

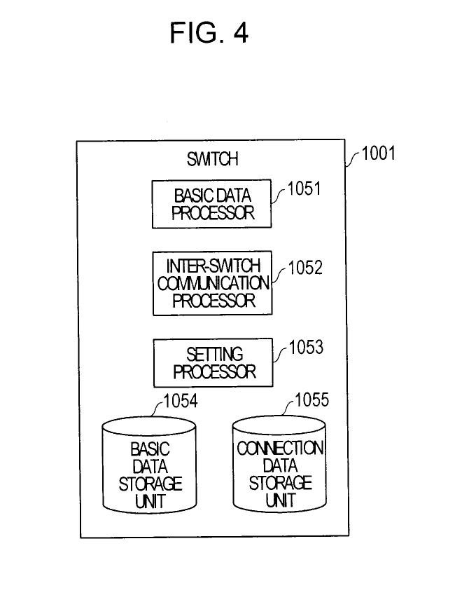

The domain ID set using the physical interface is notified to the CPU. The CPU implements the function of FIG. 4 by executing the program stored in the NVRAM. More specifically, the switch 1001 includes a basic data processor 1051, an inter-switch communication processor 1052, a setting processor 1053, a basic data storage unit 1054, and a connection data storage unit 1055.

The basic data processor 1051 performs processes including acquiring the domain ID from the physical interface, such as the DIP switch, and receiving an allocation of the IP address from the apparatus setting server 1400. The inter-switch communication processor 1052 transmits data of the switch to other switches via a port, receives data from other switches, and stores the received data in the connection data storage unit 1055. The setting processor 1053 transmits a setting generation request to the apparatus setting server 1400, receives setting data from the apparatus setting server 1400, and executes setting processing based on the received setting data.

The basic data storage unit 1054 and the connection data storage unit 1055 are implemented as data storage regions arranged in the NVRAM, for example. The basic data storage unit 1054 stores at least part of data that is configured when a command included in the setting data received from the apparatus setting server 1400 is executed.

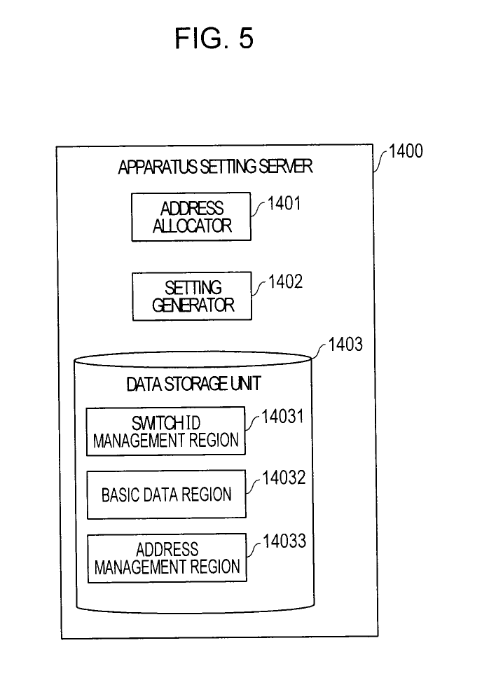

Referring to FIG. 5, the apparatus setting server 1400 is an information processing apparatus, such as a computer. The apparatus setting server 1400 includes an address allocator 1401, a setting generator 1402, and a data storage unit 1403. The address allocator 1401 has a dynamic host configuration protocol (DHCP) function, and notifies the IP address of the apparatus setting server 1400 to the switch while allocating the IP address to the switch and notifying the allocated IP address to the switch. The setting generator 1402 operates in response to a setting generation request from the switch, generates setting data including a setting command, and transmits the generated setting data to the switch that has issued the setting generation request.

The data storage unit 1403 includes a switch ID management region 14031, a basic data region 14032, and an address management region 14033.

The switch ID management region 14031 is a data storage region for managing switch IDs that have been allocated to each switch in each domain. The basic data region 14032 stores the domain ID of the root domain in the network virtualized switch 1000 to be configured, and stores the NVSID that is the ID of the network virtualized switch 1000. The address management region 14033 stores information on a range of IP addresses to be allocated to switches and the allocated IP addresses.

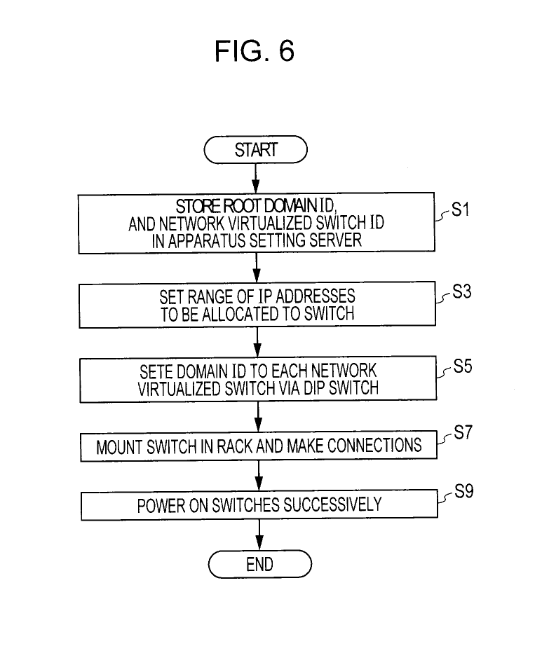

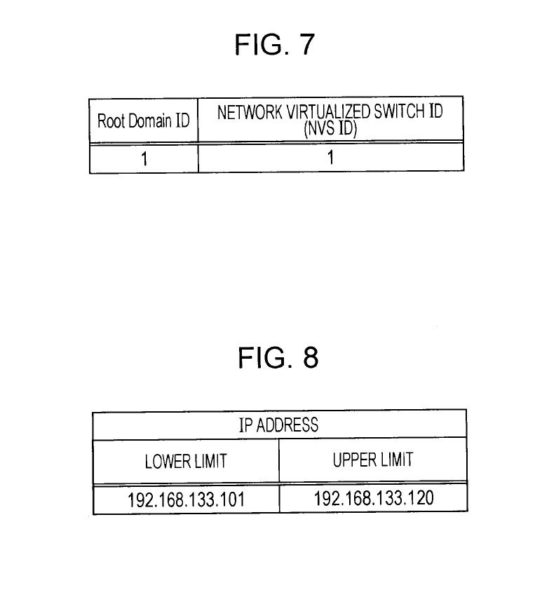

FIG. 6 is a diagram illustrating an example of an operational sequence to be performed by a network implementer, according to an embodiment. The network implementer stores the domain ID of the root domain (root domain ID) and the network virtualized switch ID (NVSID) in the apparatus setting server 1400 (step S1). For example, the data of FIG. 7 is stored in the basic data region 14032 of the data storage unit 1403. In the example of FIG. 7, the root domain ID is “1”, and the network virtualized switch ID is “1”.

The network implementer configures a range of the IP address to be allocated to the switch (step S3). For example, the data of FIG. 8 is stored in the address management region 14033 of the data storage unit 1403. In the example of FIG. 8, the lower limit of the range is “192.168.133.101”, and the upper limit of the range is “192.168.133.120”.

The network implementer sets, to each switch included in the network virtualized switch 1000, a domain ID identifying a domain to which the each switch belongs, using the physical interface, such as the DIP switch or the dial (step S5).

The network implementer mounts the switch to which the domain ID has been set, onto a rack, and performs cable-connection of the switch in accordance with the design (step S7).

The network implementer successively powers on the switches in the network virtualized switch 1000 (step S9).

Once the network implementer performs the operations as described above, the processes described below are performed and the network virtualized switch 1000 is automatically configured.

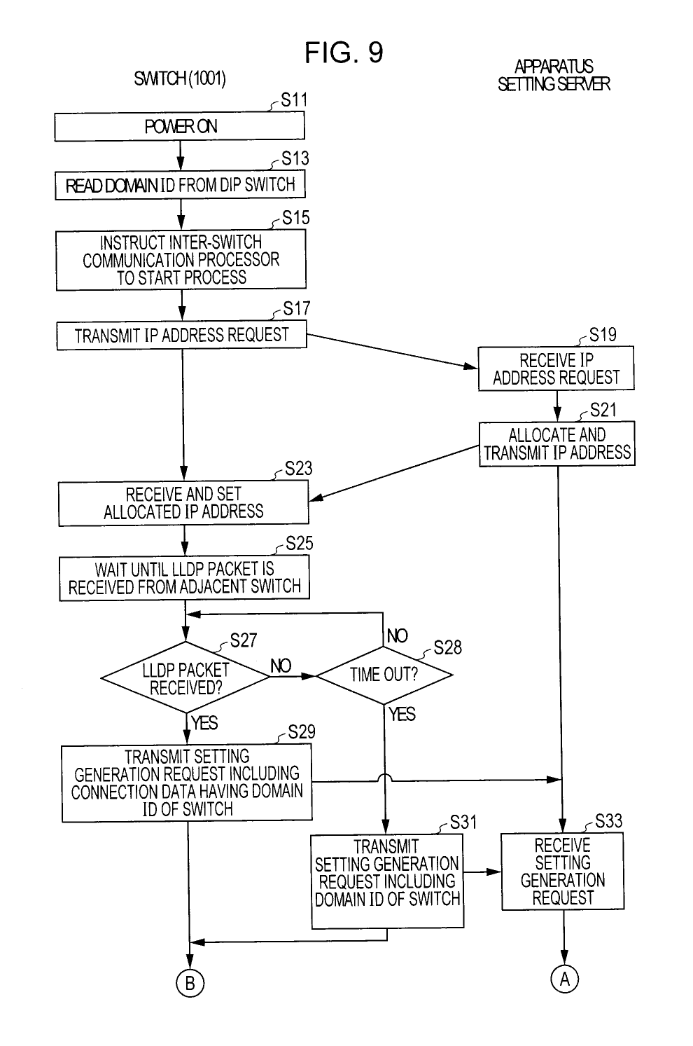

The operations of the apparatus setting server 1400 and each of the switches are described with reference to FIG. 9 through FIG. 22.

When the switch 1001 is powered on (step S11 in FIG. 9), the basic data processor 1051 reads the domain ID of the switch 1001 from the DIP switch or the like (step S13). The basic data processor 1051 instructs the inter-switch communication processor 1052 to start the process thereof (step S15). However, when the domain ID and the switch ID are not set to the switch 1001, the inter-switch communication processor 1052 does not notify the domain ID, the transmission source port number, and the switch ID of the switch 1001 from each port via a link layer discovery protocol (LLDP) packet even if instructed to start the process.

The basic data processor 1051 transmits an IP address request as a DHCP request message to the apparatus setting server 1400 (step S17). In response, the address allocator 1401 of the apparatus setting server 1400 receives the IP address request from the switch 1001 (step S19), allocates an available IP address from within the range of IP address stored in the address management region 14033, and transmits to the requesting switch 1001 a message including the allocated IP address and then IP address of the apparatus setting server 1400 (step S21).

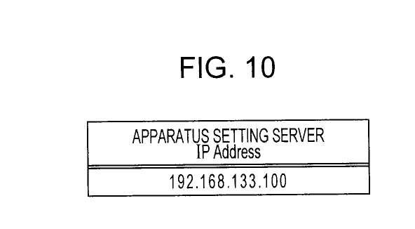

Upon receiving the message including the allocated IP address and the IP address of the apparatus setting server 1400 from the apparatus setting server 1400, the basic data processor 1051 of the switch 1001 sets the allocated IP address to the switch 1001 (step S23). The IP address of the apparatus setting server 1400 is stored in the basic data storage unit 1054. For example, the data of FIG. 10 is stored in the basic data storage unit 1054.

The setting processor 1053 waits until the inter-switch communication processor 1052 receives an LLDP packet from an adjacent switch connected to any port of the switch 1001 (step S25). A timer to measure a predetermined period of time starts down-counting. When the inter-switch communication processor 1052 has not received the LLDP packet yet (NO in step S27), the setting processor 1053 determines whether the predetermined period of time has elapsed, or whether time out occurs on the timer (step S28). When the predetermined period of time has not elapsed yet, processing returns to step S27.

When the switch 1001 is a switch that has been powered on first, since no LLDP packet is received from an adjacent switch, time out occurs on the timer, and the setting processor 1053 transmits to the apparatus setting server 1400 a setting generation request including the domain ID of the switch 1001 (step S31). For example, when the domain ID of the switch 1001 is “1”, the setting generation request including data representing the domain ID “1” is transmitted.

When inter-switch communication processor 1052 receives the LLDP packet from a switch that is different from the switch 1001 and in the domain of the switch 1001 (YES in step S27), the inter-switch communication processor 1052 stores, in the connection data storage unit 1055, connection data including the transmission source port number of the adjacent switch, the switch ID and the domain ID of the adjacent switch, and the port number of a port of the switch 1001 having received the LLDP packet. The setting processor 1053 reads out, from the basic data storage unit 1054, the connection data including the same domain ID as the domain ID of the switch 1001, and transmits to the apparatus setting server 1400 the setting generation request including the connection data and the domain ID of the switch 1001 (step S29). Since the domain ID is common, the domain ID may be excluded from the connection data in the case where the domain ID of the switch 1001 is separately transmitted.

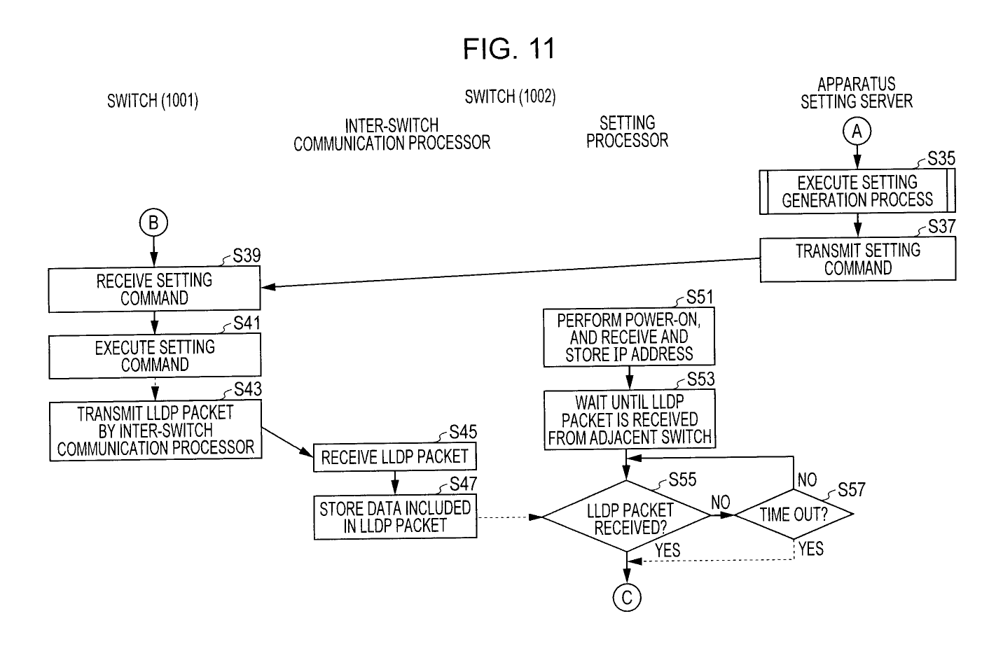

The setting generator 1402 of the apparatus setting server 1400 receives the setting generation request from the switch 1001 (step S33). The setting generation request may or may not include the connection data. Processing proceeds to a process of FIG. 11 via connectors A and B.

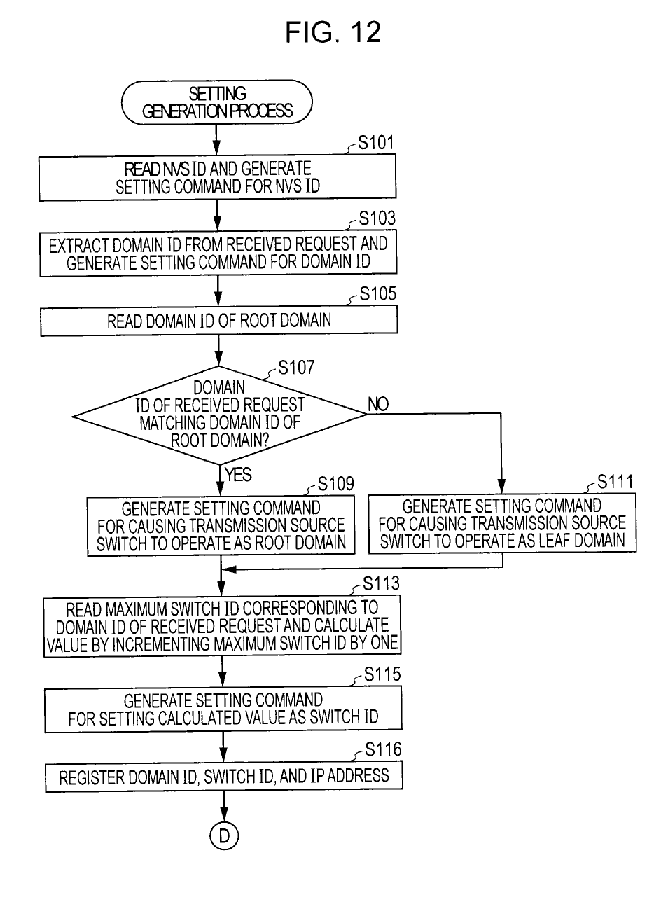

Referring to FIG. 11, the setting generator 1402 in the apparatus setting server 1400 performs a setting generation process in response to the setting generation request (step S35). The setting generation process is described with reference to FIG. 12 through FIG. 16.

The setting generator 1402 reads the network virtualized switch ID (NVS ID) from the basic data region 14032, and generates a setting command for NVS ID (step S101 in FIG. 12), such as “set NVS ID 1”.

The setting generator 1402 extracts a domain ID from the received setting generation request, and generates the setting command for the domain ID (step S103). A command, such as “set Domain ID 1”, is generated.

The setting generator 1402 reads the domain ID of the root domain from the basic data region 14032 (step S105). The setting generator 1402 determines whether the domain ID extracted from the received setting generation request matches the domain ID of the root domain (step S107).

When the two domain IDs match, the setting generator 1402 generates a setting command for causing the transmission source switch of the setting generation request to operate as a root domain (step S109). For example, a command, such as “set Domain Role root”, is generated. Processing then proceeds to step S113.

When the two domain IDs do not match, the setting generator 1402 generates the setting command for causing the transmission source switch of the setting generation request to operate as a leaf domain (step S111). For example, a command, such as “set domain role leaf”, is generated. Processing then proceeds to step S113.

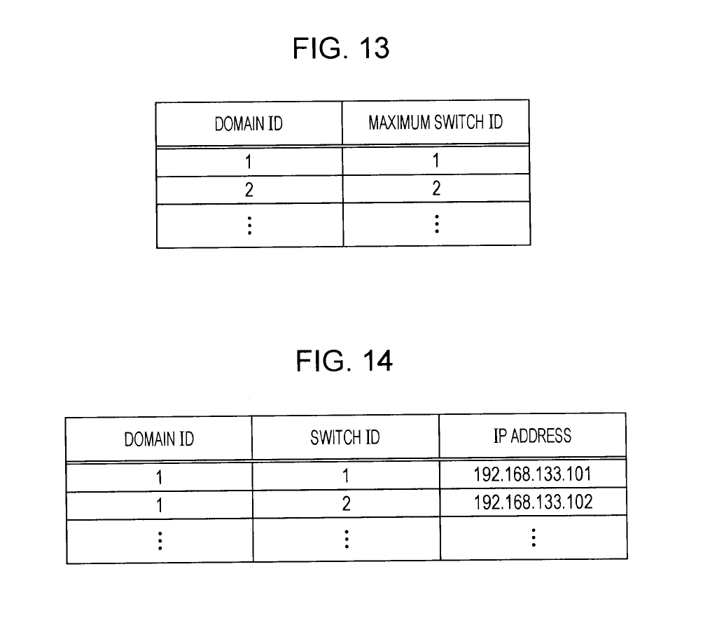

The setting generator 1402 reads, from the switch ID management region 14031, a maximum switch ID that is maximum among switch IDs associated with the domain ID of the received setting generation request, and increments the maximum switch ID by 1 (step S113). For example, the data of FIG. 13 is stored in the switch ID management region 14031. Referring to FIG. 13, the maximum switch ID is registered for each domain ID. When the domain ID is first received, “0” is initially set as the maximum switch ID therefor, and the initial value “0” is read and incremented by 1.

The setting generator 1402 generates the setting command for setting the calculated value as a switch ID (step S115), such as “set switch ID 1.”

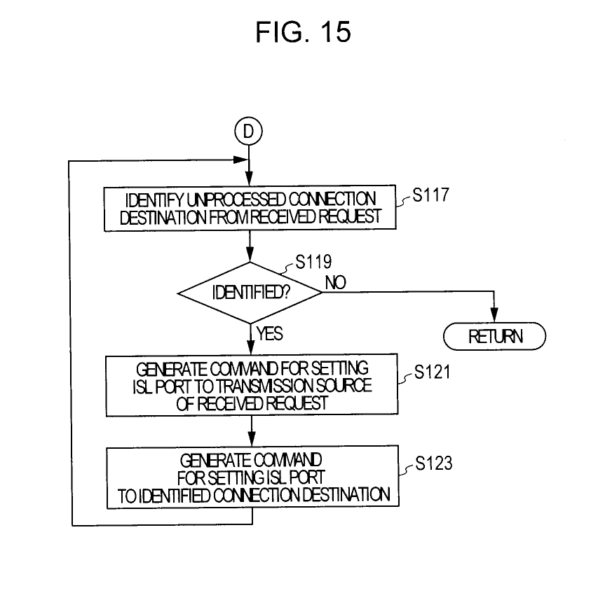

The setting generator 1402 stores, in the address management region 14033, the domain ID of the setting generation request, the calculated switch ID, the transmission source IP address of the setting generation request (step S116). For example, the data of FIG. 14 is stored in the address management region 14033. In the example of FIG. 14, the IP address is stored in association with each combination of the domain ID and the switch ID. Processing then proceeds to a process of FIG. 15 via an connecter D.

Referring to FIG. 15, the setting generator 1402 identifies an unprocessed connection destination from the received setting generation request (step S117). When the switch 1001 first transmits a setting generation request, no connection data is included in the setting generation request. However, when the switch 1001 that has received the LLDP packet from an adjacent switch transmits a setting generation request, the connection data is included in the setting generation request. When plural LLDP packets have been received from a plurality of adjacent switches at the transmission timing of a setting generation request, the connection data for the plurality of connection destination switches is included in the setting generation request. In the embodiment, an unprocessed connection destination is identified using the setting generation request in step S117.

When an unprocessed connection destination is not identified in the setting generation request (NO in step S119), in other words, when no connection data is included in the received setting generation request or when all the connection destination switches indicated by the received setting generation request are processed, processing returns to the calling process.

When the unprocessed connection destination is identified (YES in step S119), the setting generator 1402 generates a command for setting an ISL port to a transmission source switch of the received setting generation request (step S121). For example, when the connection data included in the setting generation request indicates that a port, having a port number “1”, of the transmission source switch of the setting generation request is connected to a port, having a port number “5”, of an adjacent switch having a switch ID “1”, a command “set ISL port No. 1” is generated.

Further, the setting generator 1402 generates a command for setting an ISL port to the identified connection destination switch (step S123). In the example of step S121, a command “set ISL port No. 5” is generated, and processing returns to step S117.

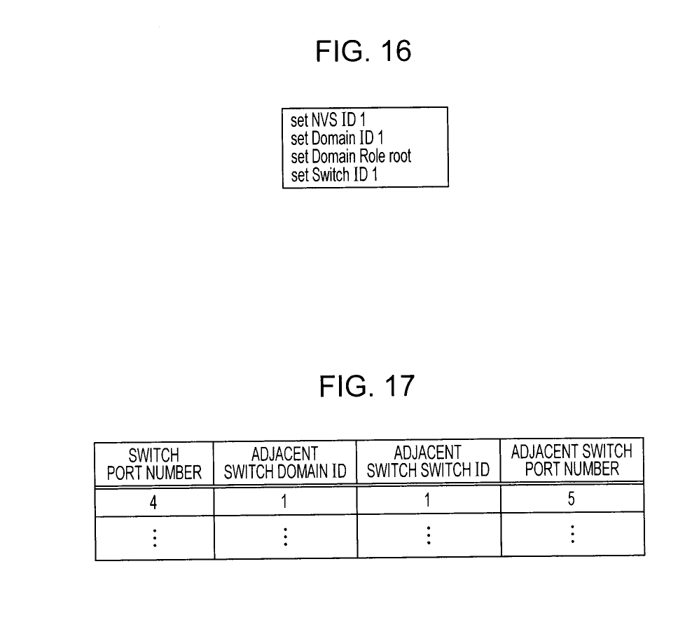

The above mentioned processes allow not only the basic setting of NVS ID, the domain ID, the role of that domain, and the switch ID, but also the setting of port numbers to a pair of ports via which an ISL connects the two switches. When the switch 1001 first transmits a setting generation request, the connection data is not included in the setting generation request, and a command of FIG. 16 is generated.

Returning back to the description of FIG. 11, the setting generator 1402 transmits the generated setting command to the transmission source switch of the setting generation request (step S37).

The setting processor 1053 in the switch 1001 receives the setting command from the apparatus setting server 1400 (step S39), and executes the received setting command (step S41). In this way, processing including setting of the switch ID is performed on the switch 1001.

Since the switch ID is allocated to the switch 1001, the inter-switch communication processor 1052 transmits, to an adjacent switch, an LLDP packet including the domain ID, the switch ID, and the port number of the transmission source (step S43). In this case, the LLDP packet is transmitted to the switch 1002.

As in the switch 1001, the setting processor 1053 of the switch 1002 performs power-on (step S11), and the reception and setting of the IP address (step S23) (step S51). This process includes an operation of the address allocator 1401 of the apparatus setting server 1400, but is performed in a manner similar to the process of the switch 1001. The description of the process is thus omitted herein.

The setting processor 1053 in the switch 1002 waits until the inter-switch communication processor 1052 receives an LLDP packet from an adjacent switch connected to any port of the switch 1002 (step S53). In a way similar to step S25, the timer starts counting down to measure a predetermined period of time.

When the inter-switch communication processor 1052 of the switch 1002 has not received an LLDP packet from an adjacent switch (NO in step S55), the setting processor 1053 determines whether the predetermined period of time has elapsed or whether time out occurs on the timer (step S57). When the predetermined period of time has not elapsed, processing proceeds to step S55.

In the case where the switch 1002 is a switch that has been powered on first, no LLDP packet is received from an adjacent switch. In the case, since the switch 1001 is powered on earlier, no time out occurs.

Since the switch 1001 transmits an LLDP packet as mentioned above, the inter-switch communication processor 1052 in the switch 1002 receives the LLDP packet (step S45). The inter-switch communication processor 1052 stores, in the connection data storage unit 1055, the data (the domain ID, the switch ID, and the transmission source port number) included in the LLDP packet together with the reception port number (step S47). FIG. 17 illustrates an example of the data to be stored in the connection data storage unit 1055. In the example of FIG. 17, the stored data includes the port number of the port having received the LLDP packet, the domain ID of the adjacent switch, the switch ID of the adjacent switch, and the port number of the adjacent switch.

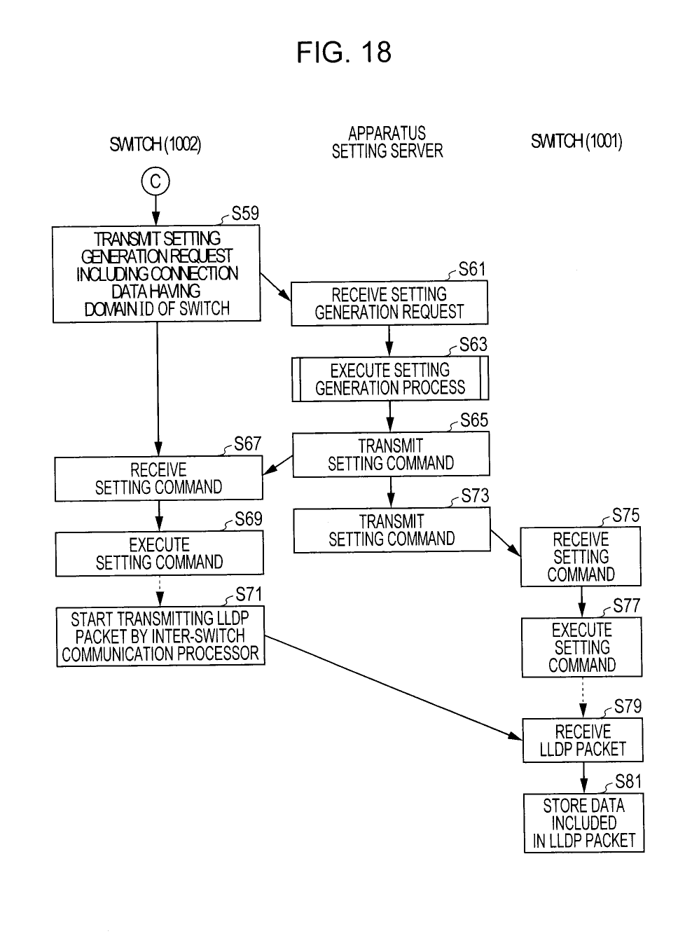

As described above, the setting processor 1053 determines that the LLDP packet has been received from the adjacent switch in the domain of the switch 1002 (YES in step S55) when the reception of the LLDP packet from the adjacent switch in the domain of the switch 1002 is reflected in the connection data storage unit 1055, or when the setting processor 1053 has received from the inter-switch communication processor 1052 a notification that the LLDP packet has been received from the adjacent switch in the domain of the switch 1002. Processing proceeds to a process of FIG. 18 via an connecter C.

Referring to FIG. 18, the setting processor 1053 of the switch 1002 reads out, from the basic data storage unit 1054, connection data including the same domain ID as the domain ID of the switch 1002, and then transmits the setting generation request including the connection data to the apparatus setting server 1400 (step S59). For example, it is assumed that the read data includes the port number “18” of the switch 1002, the domain ID “1” of the adjacent switch, the switch ID “1” of the adjacent switch, and the port number “18” of the adjacent switch.

The setting generator 1402 of the apparatus setting server 1400 receives the setting generation request from the switch 1002 (step S61). The setting generator 1402 of the apparatus setting server 1400 executes a setting generation process in response to the setting generation request (step S63). The setting generation process is identical to the process previously described with reference to FIG. 12 through FIG. 16.

In the case, since the switch ID “2” is allocated to the switch 1002 and the connection data is included in the setting generation request, a setting command “set ISL port 18” is generated.

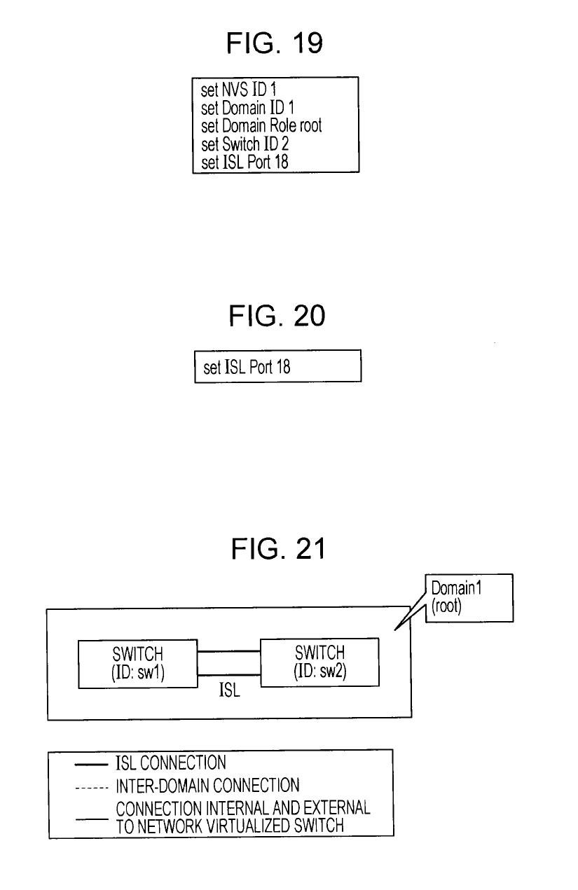

A setting command as illustrated in FIG. 19 is generated for the transmission source switch 1002 of the setting generation request. In the example of FIG. 19, an ISL port setting command for one connection destination switch is also included in addition to the basic setting command for the switch 1002.

In step S123 of FIG. 15, a setting command as illustrated in FIG. 20 is generated for the switch 1001 from the connection data. Only the ISL port setting command is generated for the connection destination switch 1001.

The setting generator 1402 of the apparatus setting server 1400 transmits the generated setting command (FIG. 19) to the transmission source switch 1002 of the setting generation request (step S65).

The setting processor 1053 of the switch 1002 receives the setting command from the apparatus setting server 1400 (step S67), and executes the received setting command (step S69). Processing including setting of the switch ID is thus performed on the switch 1002.

In this way, the switch ID is also allocated to the switch 1002. The inter-switch communication processor 1052 in the switch 1002 thus transmits, to an adjacent switch, the LLDP packet including the domain ID, the switch ID, and the port number of the transmission source (step S71). In the case, the connection data including the port number, the domain ID, and the switch ID of the switch 1002 is transmitted to the switch 1001 via the LLDP packet.

The setting generator 1402 of the apparatus setting server 1400 transmits the generated setting command (FIG. 20) to the connection destination switch 1001 (step S73). The setting generator 1402 identifies the IP address of the switch 1001 from the switch ID, with reference to the data stored in the address management region 14033, and then transmits the setting command to the switch 1001.

The setting processor 1053 of the switch 1001 receives the setting command from the apparatus setting server 1400 (step S75), and executes the received setting command (step S77) so that the ISL port is set.

Upon receiving the LLDP packet from the adjacent switch 1002 (step S79), the inter-switch communication processor 1052 of the switch 1001 stores the connection data included in the LLDP packet together with the port number of the reception port, in the connection data storage unit 1055.

Note that, for example, transmission of the LLDP packet is periodically performed.

The above mentioned processes reduce the workload of the network implementer and avoid a failure in implementing the network virtualized switch that is caused by an error, thereby enhancing work efficiency.

As mentioned above, once each switch has transmitted the setting generation request to the apparatus setting server 1400, the basic setting is performed on the each switch. As for an ISL that is later detected for the other switches, setting is performed individually.

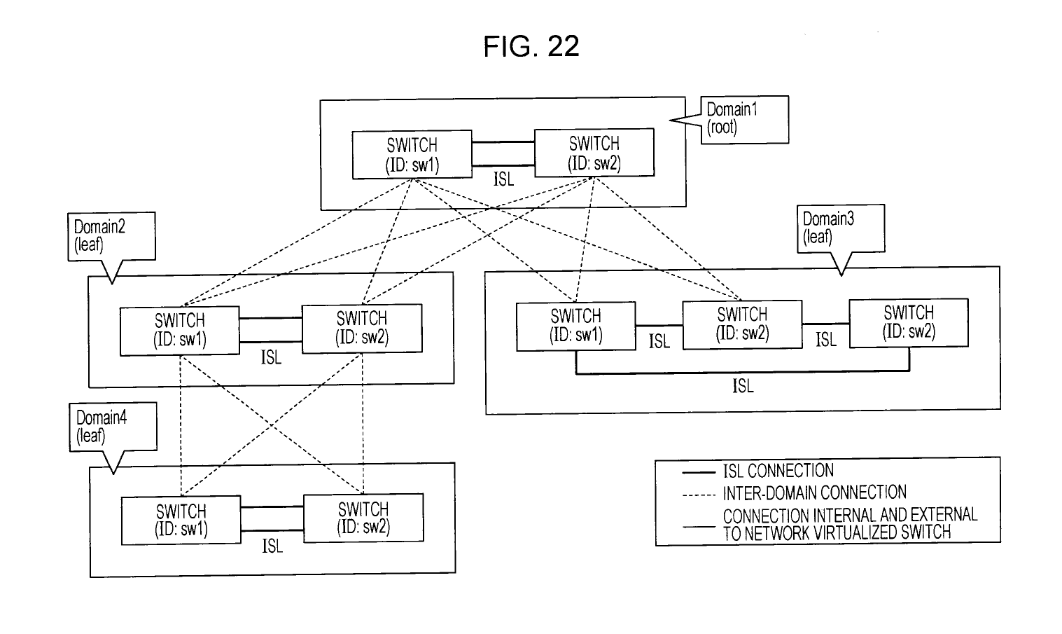

The embodiment is also applicable to the construction of the network virtualized switch having only a root domain as illustrated in FIG. 21. The embodiment is applicable not only to the system of FIG. 1 where the leaf domains are arranged in parallel under the root domain, but also to a system of FIG. 22 where another leaf domain is arranged under a leaf domain. These arrangements have been described for exemplary purposes only. The embodiment is also applicable to a system of a general network virtualized switch.

The embodiments have been described as above. However, the technique is not limited to the above described embodiments. For example, as long as the same process results are obtained, a plurality of steps may be performed in parallel in the process flow, or the order of the steps may be partially reversed.

The functional blocks of the switch 1001 through the switch 1007, and the apparatus setting server 1400 have been described for exemplary purposes only, and the program module structure and the file structure thereof may not necessarily exactly agree with those described herein. For example, the DHCP functional block of the apparatus setting server 1400 may be executed by a separate computer.

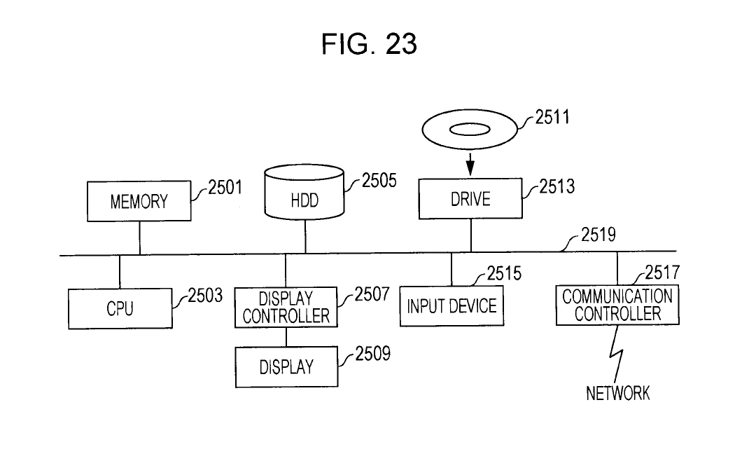

As illustrated in FIG. 23, the apparatus setting server 1400 may be a computer and includes a memory 2501, a central processing unit (CPU) 2503, a hard disk drive (HDD) 2505, a display controller 2507 connected to a display 2509, a drive 2513 for a removable disk 2511, an input device 2515, a communication controller 2517, and a bus 2519 configured to interconnect these elements. An operating system (OS) and an application program to implement the processes of the embodiment are stored on the HDD 2505. The OS and the application program, when executed by the CPU 2503, are read from the HDD 2505 to the memory 2501. In accordance with the application program, the CPU 2503 controls the display controller 2507, the communication controller 2517, and the drive 2513 to perform a predetermined operation. The data under process is stored on the memory 2501, but may also be stored on the HDD 2505. In the embodiment of the technique, the application program to implement the above-described processes is distributed in a recorded state on the removable disk 2511, and then installed from the drive 2513 to the HDD 2505. The application program may be installed on the HDD 2505 via a network, such as the Internet, and the communication controller 2517. The computer performs a variety of functions including those described above when hardware including the CPU 2503 and the memory 2501 operates in cooperation with programs including the OS and the application program.

The embodiment is summarized as described below.

The network system of the embodiment includes a plurality of switches, each switch having a memory, and an information processing apparatus that sets the plurality of switches. A domain identifier identifying a domain to which each of the plurality of switches belongs is beforehand set to the each switch. Each of the one or more domains has two or more switches belonging thereto. Each of the plurality of switches, upon receiving information from another switch in a state where a first switch identifier identifying the each switch is not set, store in the memory, as connection data, the information together with a first port identifier identifying a port of the each switch via which the first information is received, where the information includes a domain identifier identifying a domain to which the another switch belongs, a second switch identifier identifying the another switch, and a second port identifier identifying a port of the another switch via which the first information is transmitted from the another switch. The each switch reads out, from the memory, the connection data including a domain identifier identifying a domain to which the each switch belongs, and transmits, to the information processing apparatus, connection data that includes the domain identifier, the first switch identifier, the first port identifier, and the second port identifier. The information processing apparatus, upon receiving the connection data from the each switch, allocates as the first switch identifier an identifier unique to the domain to which the each switch belongs, generates first setting data that is adapted to set the first switch identifier to the each switch that has transmitted the connection data and to set a port of the each switch identified by the first port identifier as an in-domain link port, and transmits the generated first setting data to the each switch that has transmitted the connection data, and generates second setting data that is adapted to set a port of the another switch identified by the second port identifier as an in-domain link port, and transmits the generated second setting data to the another switch identified by the second switch identifier.

In this way, the network virtualized switch is appropriately implemented. The workload on the network implementer is reduced, and the occurrence of operational errors in implementation work is thus controlled.

Each of the plurality of switches may, when the first information is not received from the another switch belonging to the same domain as the each switch for a predetermined period of time since a startup of the each switch, transmit, to the information processing apparatus, a request including a domain identifier identifying a domain to which the each switch belongs. The information processing apparatus may, upon receiving the request, allocates, to the each switch that has transmitted the request, as the first switch identifier, an identifier unique to the domain to which the each switch belongs, generates third setting data that is adapted to set the first switch identifier to the each switch, and transmits the generated third data to the each switch.

The switch that has started up first operates after obtaining the first switch identifier in this way.

Each of the plurality of switches may transmit, from each port of the each switch to a connection destination, a domain identifier identifying a domain to which the each switch belongs, and the first switch identifier identifying the each switch. This allows a switch other than the switch that has started up first to also be automatically configured.

The information processing apparatus may include a data storage unit to store a root domain identifier identifying a domain that is adapted to function as a root domain among the one or more domains. The information processing apparatus may be further configured: to, when a domain identifier included in the connection data has a value identical to the root domain identifier stored in the data storage unit, generate third setting data that is adapted to set a domain identified by the domain identifier as the root domain, and to, when a domain identifier included in the connection data has a value different from the root domain identifier stored in the data storage unit, generate fourth setting data that is adapted to set a domain identified by the domain identifier as a leaf domain.

This allows the role of the domain to be automatically configured.

Each of the plurality of switches may include a physical interface that is configured to set a domain identifier to the each switch. With this arrangement, the workload on the network implementer is reduced, and the occurrence of operational errors in implementation work is controlled.

A switch of the embodiment includes a memory and a processor coupled to the memory. The processor is configured: to, upon receiving from another switch, information that includes a domain identifier identifying a domain to which the another switch belongs, a first switch identifier identifying the another switch, and a first port identifier identifying a port of the another switch via which the information is transmitted from the another switch, store the information together with a second port identifier identifying a port of the each switch via which the information is received, as connection data, in the memory of the switch; to read out, from the memory, the connection data including a domain identifier identifying a domain to which the switch belongs; to transmit, to the information processing apparatus, the connection data that includes the domain identifier, the first switch identifier, the first port identifier, and the second port identifier; and to, upon receiving setting data from the information processing apparatus, set the switch according to the received setting data, where the setting data is adapted to set a second switch identifier allocated to the switch and to set a port of the switch identified by the second port identifier as an in-domain link port.

An information processing apparatus of the embodiment includes a memory and a processor coupled to the memory. The processor is configured: to receive from a first switch, connection data that includes a domain identifier identifying a domain to which the first switch belongs, a first switch identifier identifying a second switch connected to the first switch, a first port identifier identifying a port of the first switch via which the first switch is connected to the second switch, and a second port identifier identifying a port of the second switch via which the second switch is connected to the first switch; to allocate a second switch identifier unique to the domain to which the first switch belongs, to the first switch; to generate first setting data that is adapted to set the second switch identifier allocated to the first switch and to set a port of the first switch identified by the first port identifier as an in-domain link port, and transmit the generated first setting data to the first switch; and to generate second setting data that is adapted to set a port of the second switch identified by the second port identifier as an in-domain link port, and transmit the generated second setting data to the second switch.

A program causing a processor or a computer to perform the above-described processes may be produced. The program may be stored on computer readable storage media or storage device. The storage media include a flexible disk, an optical disk, such as a compact disk read-only memory (CD-ROM), a magneto-optical disk, a semiconductor memory (such as ROM), and a hard disk. Data under process may be temporarily stored on a storage device, such as a random-access memory (RAM).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A network system comprising:
a plurality of switches each including a memory and belonging to one of one or more domains, the one or more domains each including two or more switches belonging thereto; and
an information processing apparatus configured to set the plurality of switches, wherein
a domain identifier identifying a domain to which each of the plurality of switches belongs is beforehand set to the each switch;
each of the plurality of switches is configured:
to, upon receiving information from another switch in a state where a first switch identifier identifying the each switch is not set, store in the memory, as connection data, the information together with a first port identifier identifying a port of the each switch via which the information is received, the information including a domain identifier identifying a domain to which the another switch belongs, a second switch identifier identifying the another switch, and a second port identifier identifying a port of the another switch via which the information is transmitted from the another switch,
to read out, from the memory, the connection data including a domain identifier identifying a domain to which the each switch belongs, and
to transmit, to the information processing apparatus, the connection data that includes the domain identifier, the first switch identifier, the first port identifier, and the second port identifier; and
the information processing apparatus is configured:
to, upon receiving the connection data from the each switch, allocate, as the first switch identifier, an identifier unique to a domain to which the each switch belongs,
to generate first setting data that is adapted to set the first switch identifier to the each switch and to set a port of the each switch identified by the first port identifier as an in-domain link port, and transmit the generated first setting data to the each switch that has transmitted the connection data, and
to generate second setting data that is adapted to set a port of the another switch identified by the second port identifier as an in-domain link port, and transmit the generated second setting data to the another switch identified by the second switch identifier.

2. The network system of claim 1, wherein
when the information is not received from the another switch belonging to a same domain as the each switch for a predetermined period of time since a startup of the each switch, the each switch transmits, to the information processing apparatus, a request including a domain identifier identifying the same domain to which the each switch belongs;
the information processing apparatus, upon receiving the request, allocates, to the each switch that has transmitted the request, as the first switch identifier, an identifier unique to the domain to which the each switch belongs; and
the information processing apparatus generates third setting data that is adapted to set the allocated switch identifier to the each switch, and transmits the generated third setting data to the each switch.

3. The network system of claim 1, wherein
each of the plurality of switches transmits, from each port of the each switch to a connection destination, a domain identifier identifying a domain to which the each switch belongs, and a switch identifier identifying the each switch.

4. The network system of claim 1, wherein
the information processing apparatus includes a data storage unit to store a root domain identifier identifying a domain that is adapted to function as a root domain among the one or more domains; and
the information processing apparatus is further configured:
to, when a domain identifier included in the connection data has a value identical to the root domain identifier stored in the data storage unit, generate third setting data that is adapted to set a domain identified by the domain identifier as the root domain, and
to, when a domain identifier included in the connection data has a value different from the root domain identifier stored in the data storage unit, generate fourth setting data that is adapted to set a domain identified by the domain identifier as a leaf domain.

5. The network system of claim 1, wherein
each of the plurality of switches includes a physical interface that is configured to set a domain identifier to the each switch.

6. A switch comprising:
a memory; and
a processor coupled to the memory, the processor being configured:
to, upon receiving from another switch, information that includes a domain identifier identifying a domain to which the another switch belongs, a first switch identifier identifying the another switch, and a first port identifier identifying a port of the another switch from which the information is transmitted from the another switch, store the information together with a second port identifier identifying a port of the switch via which the information is received, as connection data, in the memory of the switch,
to read out, from the memory, the connection data including a domain identifier identifying a domain to which the switch belongs,
to transmit, to an information processing apparatus for setting a plurality of switches, the connection data that includes the domain identifier, the first switch identifier, the first port identifier, and the second port identifier, and
to, upon receiving setting data from the information processing apparatus, set the switch according to the received setting data, the setting data being adapted to set a second switch identifier allocated to the switch and to set a port of the switch identified by the second port identifier as an in-domain link port.

7. An information processing apparatus for setting a plurality of switches, the information processing apparatus comprising:
a memory; and
a processor coupled to the memory, the processor being configured:
to receive from a first switch, connection data that includes a domain identifier identifying a domain to which the first switch belongs, a first switch identifier identifying a second switch connected to the first switch, a first port identifier identifying a port of the first switch via which the first switch is connected to the second switch, and a second port identifier identifying a port of the second switch via which the second switch is connected to the first switch,
to allocate a second switch identifier unique to the domain to which the first switch belongs, to the first switch,
to generate first setting data that is adapted to set the second switch identifier allocated to the first switch and to set a port of the first switch identified by the first port identifier as an in-domain link port, and transmit the generated first setting data to the first switch, and
to generate second setting data that is adapted to set a port of the second switch identified by the second port identifier as an in-domain link port, and transmit the generated second setting data to the second switch.

8. A method executed by a switch, the method comprising:
upon receiving, from another switch, information that includes a domain identifier identifying a domain to which the another switch belongs, a first switch identifier identifying the another switch, and a first port identifier identifying a port of the another switch via which the information is transmitted from the another switch, storing, as connection data, in the memory of the switch, the information together with a second port identifier identifying a port of the switch via which the information is received from the another switch;
reading out, from the memory, the connection data including a domain identifier identifying a domain to which the switch belongs;
transmitting, to the information processing apparatus, the connection data that includes the domain identifier, the first switch identifier, the first port identifier, and the second port identifier; and
upon receiving setting data from the information processing apparatus, set the switch according to the received setting data, the setting date being adapted to set a second switch identifier allocated to the switch and to set a port of the switch identified by the second port identifier as an in-domain link port.

9. A method for setting a plurality of switches, the method comprising:
receiving, from a first switch, connection data that includes a domain identifier identifying a domain to which the first switch belongs, a first switch identifier identifying a second switch connected to the first switch, a first port identifier identifying a port of the first switch via which the first switch is connected to the second switch, and a second port identifier identifying a port of the second switch via which the second switch is connected to the first switch;
allocating a second switch identifier unique to a domain to which the first switch belongs, to the first switch;
generating first setting data that is adapted to set the second switch identifier allocated to the first switch and to set a port of the first switch identified by the first port identifier as an in-domain link port, and transmitting the generated first setting data to the first switch; and
generating second setting data that is adapted to set a port of the second switch identified by the second port identifier as an in-domain link port, and transmitting the generated second setting data to the second switch.
